(19) United States
(12) Patent Application Publication
(10) Pub. No.: US 2025/0329938 A1
(43) Pub. Date: Oct. 23, 2025

(54) ANTENNA APPARATUS AND ARRAY ANTENNA APPARATUS

(71) Applicant: Panasonic Industry Co., Ltd., Osaka (JP)

(72) Inventors: Ryosuke HASABA, Kanagawa (JP); Takashi TOMURA, Tokyo (JP); Alberto HERNANDEZ-ESCOBAR, Tokyo (JP)

(73) Assignee: Panasonic Industry Co., Ltd., Osaka (JP)

(21) Appl. No.: 19/252,052

(22) Filed: Jun. 27, 2025

Related U.S. Application Data
(63) Continuation of application No. PCT/JP2023/046804, filed on Dec. 26, 2023.
(60) Provisional application No. 63/478,078, filed on Dec. 30, 2022.

(51) Int. Cl. H01Q 19/10; H01Q 21/00

(52) U.S. Cl. CPC H01Q 19/10; H01Q 21/00

(57) ABSTRACT

An antenna apparatus includes: a reflective plate; and an antenna element that extends perpendicularly from the reflective plate and is bent at a right angle. The length of a portion of the antenna element extending perpendicularly from the reflective plate is approximately ¼ of a guide wavelength to be radiated, and the length of a portion of the antenna element bent at a right angle and extending is approximately ¼ or longer and approximately ½ or shorter of the guide wavelength.

### TECHNICAL FIELD

The present disclosure relates to an antenna apparatus and an array antenna apparatus.

### BACKGROUND ART

Studies have been actively conducted on mobile communication using high-frequency signals such as those in millimeter-wave bands and sub-terahertz-wave bands.

The main beam direction of an antenna at a terminal and the main beam direction of an antenna at a base station such as an access point (AP) are not uniformly determined due to movement of the user. There is thus a need for a communication module that radiates radio waves in various directions.

A phased array is often used to control a radial direction. It is desired for a single antenna constituting a phased array to have, for example, isotropic radiation characteristics so as to cover as many directions as possible.

An antenna apparatus disclosed in Patent Literature (hereinafter, referred to as PTL) 1 enlarges a radiation pattern of a radio wave in a direction parallel to a substrate surface by combining a dipole antenna and a monopole antenna. For example, as illustrated in A of FIG. 426 in PTL 1, the antenna apparatus in PTL 1 forms a radiation pattern in the direction of the first end of the substrate (90-degree direction), as well as forms a radiation pattern in the direction of the second end opposite to the first end (−90-degree direction).

### CITATION LIST

### Patent Literature

PTL 1
Japanese Unexamined Patent Application Publication (Translation of PCT Application) No. 2020-507230

### SUMMARY OF INVENTION

### Technical Problem

However, in PTL 1, there is a problem in that, while the radiation pattern of the radio wave is enlarged in a direction parallel to the substrate surface, the radio wave cannot be strongly radiated in a direction perpendicular to the substrate surface.

A non-limiting embodiment of the present disclosure facilitates providing an antenna apparatus that radiates radio waves in a wide-angle radiation pattern.

### Solution to Problem

An antenna apparatus according to an embodiment of the present disclosure includes: a reflective plate; and an antenna element that extends perpendicularly from the reflective plate, in which a length of a portion of the antenna element extending perpendicularly from the reflective plate is approximately ¼ of a guide wavelength to be radiated, and a length of a portion of the antenna element bent at a right angle and extending is approximately ¼ or longer and approximately ½ or shorter of the guide wavelength.

An antenna apparatus according to an embodiment of the present disclosure is an array antenna apparatus that includes a plurality of antenna apparatuses, and each of the antenna apparatus includes: a reflective plate; and an antenna element that extends perpendicularly from the reflective plate, in which a length of a portion of the antenna element extending perpendicularly from the reflective plate is approximately ¼ of a guide wavelength to be radiated, and a length of a portion of the antenna element bent at a right angle and extending is approximately ¼ or longer and approximately ½ or shorter of the guide wavelength.

It should be noted that general or specific embodiments may be implemented as a system, an apparatus, a method, an integrated circuit, a computer program, a storage medium, or any selective combination thereof.

### Advantageous Effects of Invention

According to an embodiment of the present disclosure, an antenna apparatus can radiate radio waves in a wide-angle radiation pattern.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 is a diagram illustrating exemplary radiation of radio waves by a communication apparatus;

FIG. 2 is a diagram illustrating exemplary beam scanning;

FIG. 3 is a side cross-sectional view of an inverted-L antenna;

FIG. 4 is a side cross-sectional view of an antenna apparatus according to Embodiment 1;

FIG. 5 is a side cross-sectional view of an antenna apparatus according to Embodiment 2;

FIG. 6 is a side cross-sectional view of an antenna apparatus according to Embodiment 3;

FIG. 7 is a side cross-sectional view of an antenna apparatus according to Embodiment 4;

FIG. 8 illustrates a layer in a laminated substrate of an antenna apparatus according to Embodiment 5 as viewed from above;

FIG. 9 is a perspective view of the antenna apparatus partially showing the interior of the substrate according to Embodiment 5;

FIG. 10 illustrates a layer in a laminated substrate of an antenna apparatus according to Embodiment 6 as viewed from above;

FIG. 11 is a perspective view of the antenna apparatus partially showing the interior of the substrate according to Embodiment 6;

FIG. 12 is a side cross-sectional view of an antenna apparatus included in an array antenna apparatus according to Embodiment 7;

FIG. 13 is a top view of the antenna apparatus of FIG. 12;

FIG. 14 is a top view of the array antenna apparatus according to Embodiment 7; and

FIG. 15 is a diagram illustrating a simulation result of a radiation pattern of the array antenna apparatus.

### DESCRIPTION OF EMBODIMENTS

Hereinafter, embodiments of the present disclosure will be described in detail with reference to the drawings as appropriate. However, any unnecessarily detailed description may be omitted. For example, detailed descriptions of well-known matters and redundant descriptions of substantially the same configuration may be omitted. This is to avoid the unnecessary redundancy of the following description and to facilitate understanding of those skilled in the art.

Note that, the accompanying drawings and the following description are provided so that those skilled in the art understand the present embodiment sufficiently, and are not intended to limit the subject matters recited in the claims.

### Embodiment 1

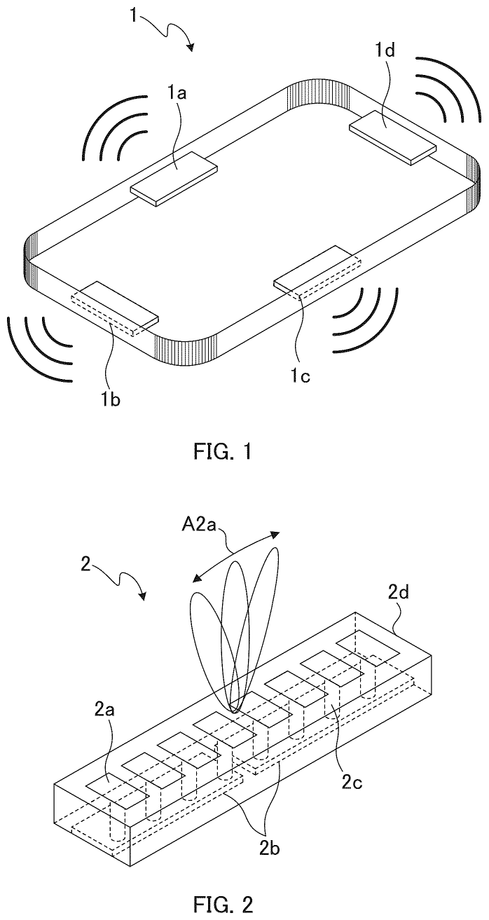

FIG. 1 is a diagram illustrating exemplary radiation of radio waves by communication apparatus 1. Communication apparatus 1 may be, for example, a mobile terminal such as a smartphone, a tablet terminal, or a notebook computer. Communication apparatus 1 may also be a base station such as an AP of a wireless Local Area Network (LAN), for example.

FIG. 1 is a transparent perspective view of communication apparatus 1. Communication apparatus 1 includes communication modules 1a to 1d inside thereof. Communication modules 1a to 1d are provided on each side of a substrate having, for example, a rectangular shape so that communication apparatus 1 can radiate radio waves in each direction.

The main beam directions of antennas of communication modules 1a to 1d are not uniformly determined due to movement of communication apparatus 1. Thus, communication modules 1a to 1d are required to radiate radio waves in various directions.

A phased array is often used to control the radial direction of a radio wave. It is desired for a single antenna constituting a phased array to have, for example, isotropic radiation characteristics so as to cover as many directions as possible.

FIG. 2 is a diagram illustrating exemplary beam scanning. As illustrated in FIG. 2, communication module 2 includes antenna elements 2a, Radio Frequency Integrated Circuits (RFICs) 2b, transmission lines 2c, and substrate 2d.

Antenna elements 2a are formed on the upper surface of substrate 2d. In FIG. 2, eight antenna elements 2a are formed.

RFICs 2b are arranged on the back surface of substrate 2d. In the example of FIG. 2, two RFICs 2b are arranged.

Transmission lines 2c are formed in substrate 2d and connect antenna elements 2a and RFICs 2b. Substrate 2d is a dielectric substrate.

Communication module 2 (RFIC 2b) scans beams by adjusting the amplitudes and phases of antenna elements 2a as indicated by arrow A2a in FIG. 2.

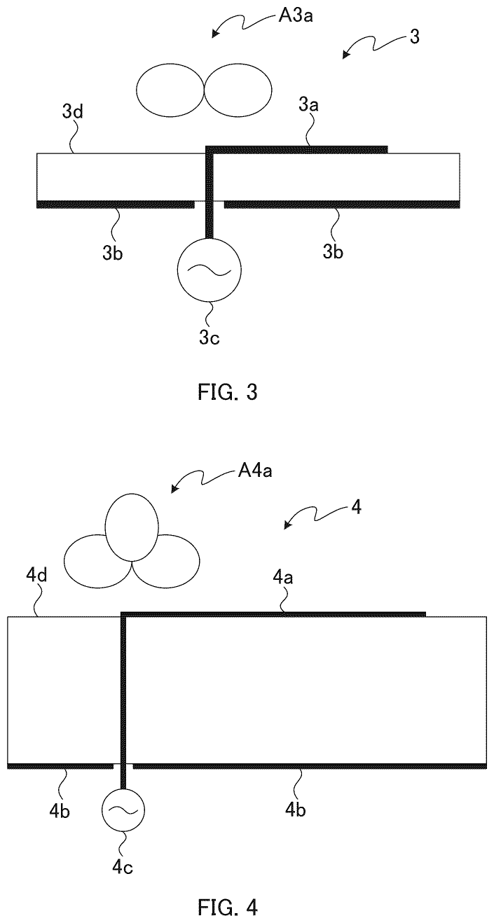

FIG. 3 is a side cross-sectional view of inverted-L antenna 3. As illustrated in FIG. 3, inverted-L antenna 3 includes antenna element 3a, reflective plate 3b, excitation source 3c, and substrate 3d. FIG. 3 also illustrates a radiation pattern of inverted-L antenna 3 as indicated by arrow A3a.

Antenna element 3a has an L-shape. Antenna element 3a extends from the back surface of substrate 3d toward the upper surface, is bent by 90 degrees, and is formed on the upper surface of substrate 3d. The length of L-shaped antenna element 3a is λ/4. λ is the wavelength of a radio wave to be radiated.

Reflective plate 3b is formed in a solid pattern on the back surface of substrate 3d. Reflective plate 3b is connected to a ground.

Excitation source 3c is connected to one end of antenna element 3a on the side of the back surface of substrate 3d. Excitation source 3c supplies power to antenna element 3a.

Substrate 3d is a dielectric substrate. The thickness of substrate 3d is λ/10 or less for a radio wave of several GHz or less so that substrate 3d can fit in a housing of a communication apparatus such as a smartphone or a tablet terminal.

When the thickness of substrate 3d is λ/10 or less with respect to the wavelength, the current flowing through antenna element 3a at the upper surface of substrate 3d and the current (virtual current) flowing through reflective plate 3b cancel each other out. Thus, the portion contributing to radio wave radiation is a portion of antenna element 3a that extends from the back surface toward the upper surface of substrate 3d. Therefore, inverted-L antenna 3 has a directivity having a figure-eight shape as indicated by arrow A3a in FIG. 3. In other words, the radiation pattern of a radio wave is formed in a direction parallel to the substrate surface.

As described above, it is desired for a single antenna constituting a phased array to have, for example, isotropic radiation characteristics so as to cover as many directions as possible. However, while the antenna apparatus in PTL 1 and inverted-L antenna 3 illustrated in FIG. 3 enlarge the radiation pattern of a radio wave in the direction parallel to the substrate surface, they cannot strongly radiate a radio wave in the direction perpendicular to the substrate surface (direction normal to the substrate). Then, the present disclosure provides an antenna apparatus and an array antenna apparatus that each form a radiation pattern also in the direction normal to the substrate.

FIG. 4 is a side cross-sectional view of antenna apparatus 4 according to Embodiment 1. As illustrated in FIG. 4, antenna apparatus 4 includes antenna element 4a, reflective plate 4b, excitation source 4c, and substrate 4d. FIG. 4 also illustrates a radiation pattern of antenna apparatus 4 as indicated by arrow A4a.

Antenna element 4a has, for example, a bar shape and is bent in an L-shape. Antenna element 4a extends perpendicularly from the back surface toward the upper surface of substrate 4d, is bent by 90 degrees, and is formed on the upper surface of substrate 4d.

In L-shaped antenna element 4a, a portion extending from the back surface toward the upper surface of substrate 4d (first antenna-element portion) has a columnar shape, for example. The length of the first antenna-element portion is ¼ of a guide wavelength (wavelength inside a dielectric) 2g. The first antenna-element portion may be formed by a via, for example.

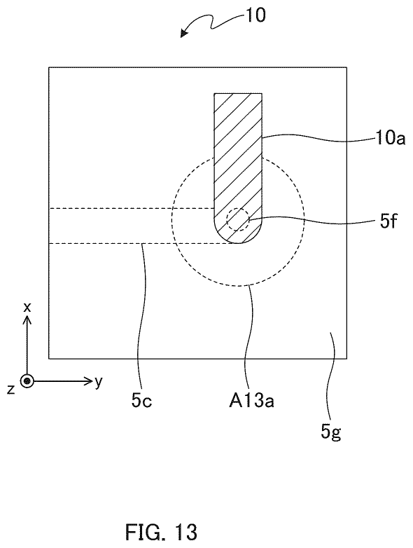

In L-shaped antenna element 4a, a portion formed on the upper surface of substrate 4d (second antenna-element portion) has, for example, an elongated rectangular shape (see, e.g., hatched portion in FIG. 13). The length of the second antenna-element portion is equal to or longer than λg/4 and equal to or shorter than λg/2. The second antenna-element portion may be formed of copper foil.

Reflective plate 4b is formed in a solid pattern on the back surface of substrate 4d. Reflective plate 4b is connected to a ground. Reflective plate 4b may be formed of copper foil.

The second antenna-element portion is formed so as to overlap with reflective plate 4b (so as to be positioned above reflective plate 4b) when viewed from the side of the upper surface of substrate 4d. In other words, the second antenna-element portion is formed to be parallel to the surface of reflective plate 4b. The distance between reflective plate 4b and the second antenna-element portion is λg/4.

Excitation source 4c is placed at one end of antenna element 4a on the side of the back surface of substrate 4d. Excitation source 4c supplies power to antenna element 4a. Excitation source 4c may be regarded as a feeding point. The feeding point may mean a connection point between a transmission line for transmitting power and antenna element 4a.

Substrate 4d is a dielectric substrate. The thickness of substrate 4d is set so that the length of the first antenna-element portion of antenna element 4a is λg/4, for example. Note that, for a millimeter-wave band or a sub-terahertz-wave band, the thickness of substrate 4d is, for example, several hundred u to several mm, allowing the substrate to fit in a housing of a communication apparatus such as a smartphone or a tablet terminal.

When the thickness of substrate 4d is thick with respect to the wavelength compared to inverted-L antenna 3 illustrated in FIG. 3, and the length of the first antenna-element portion of antenna element 4a is λg/4, the current flowing through the second antenna-element portion of antenna element 4a is not canceled by the current flowing through reflective plate 4b but strengthen each other. This causes radio waves to strongly radiate in the direction normal to substrate 4d (up and down directions in FIG. 4). That is, the second antenna-element portion of antenna element 4a contributes to the radiation of radio waves in the direction normal to substrate 4d. Thus, antenna apparatus 4 can radiate radio waves in the direction parallel to the surface of substrate 4d and the direction normal to substrate 4d as indicated by arrow A4a in FIG. 4, thereby forming a wide-angle radiation pattern.

### Summary of Embodiment 1

As described above, antenna apparatus 4 includes reflective plate 4b and antenna element 4a that extends perpendicularly from reflective plate 4b and is bent at a right angle. The length of the portion of antenna element 4a extending perpendicularly from reflective plate 4b (first antenna-element portion) is approximately ¼ of a guide wavelength to be radiated. The length of the portion of antenna element 4a bent at a right angle and extending (second antenna-element portion) is approximately ¼ or longer and approximately ½ or shorter of the guide wavelength. Thus, antenna apparatus 4 can radiate radio waves in a direction parallel to the surface of substrate 4d and a direction normal to substrate 4d, thereby forming a wide-angle radiation pattern.

### Embodiment 2

In Embodiment 2, a laminated substrate (multilayer substrate) is used as the substrate.

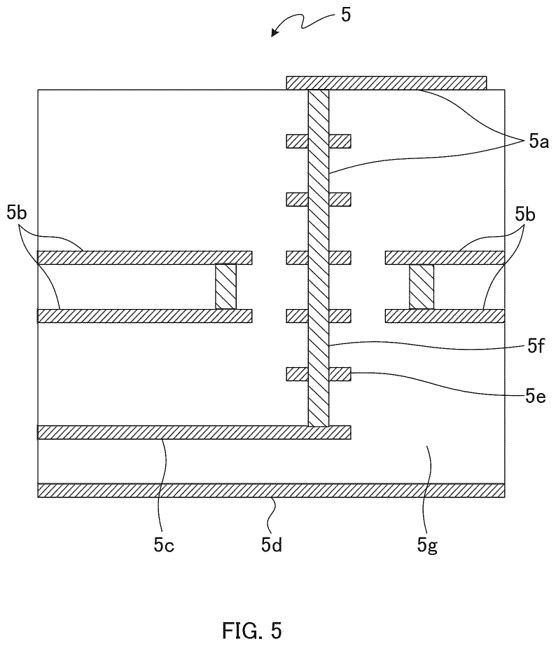

FIG. 5 is a side cross-sectional view of antenna apparatus 5 according to Embodiment 2. As illustrated in FIG. 5, antenna apparatus 5 includes antenna element 5a, reflective plate 5b, transmission line 5c, ground 5d, via lands 5e, vias 5f, and substrate 5g.

Substrate 5g is a dielectric substrate. In the example of FIG. 5, substrate 5g is a laminated substrate having eight layers of copper foil. In the description of FIG. 5, the layers are referred to as the first layer, the second layer, . . . , and the eighth layer from the upper surface toward the bottom surface of substrate 5g. In substrate 5g, via lands 5e are formed inside substrate 5g, and vias 5f are stacked on top of and below via lands 5e. Via lands 5e and vias 5f may be formed of copper.

Antenna element 5a has a shape bent in an L-shape. Antenna element 5a extends perpendicularly from the fourth layer to the first layer of substrate 5g, is bent by 90 degrees, and is formed on the upper surface of substrate 5g.

In L-shaped antenna element 5a, a portion extending perpendicularly from the fourth layer to the first layer of substrate 5g (first antenna-element portion) is formed by vias 5f. The length of the first antenna-element portion is λg/4.

In L-shaped antenna element 5a, a portion formed on the first layer of substrate 5g (second antenna-element portion) has, for example, an elongated rectangular shape (see, e.g., hatched portion in FIG. 13). The length of the second antenna-element portion is equal to or longer than λg/4 and equal to or shorter than λg/2. The second antenna-element portion may be formed of copper foil.

Reflective plate 5b is formed in a solid pattern on the fourth and the fifth layers of substrate 5g. The two layers of reflective plate 5b are connected through vias 5f. Reflective plate 5b is connected to a ground. Reflective plate 5b is formed on two layers in FIG. 5, but may be formed on one layer or may be formed on three or more layers. Reflective plate 5b may be formed of copper foil.

The second antenna-element portion is formed so as to overlap with reflective plate 5b (so as to be positioned above reflective plate 5b) when viewed from the side of the upper surface of substrate 5g. In other words, the second antenna-element portion is formed to be parallel to the surface of reflective plate 5b. The distance between reflective plate 5b and the second antenna-element portion is λg/4.

Transmission line 5c is formed in the seventh layer of substrate 5g. Transmission line 5c may be a strip line. One end of transmission line 5c is connected to the first antenna-element portion of antenna element 5a through via 5f, and the other end is connected to an RFIC (not shown), for example. Transmission line 5c supplies power from the RFIC to antenna elements 5a. Furthermore, transmission line 5c transmits power of the radio wave received by antenna element 5a to the RFIC. Transmission line 5c may be formed of copper foil.

Ground 5d is formed in a solid pattern on the eighth layer of substrate 5g. Ground 5d may be formed of copper foil.

As illustrated in FIG. 5, the first antenna-element portion of antenna element 5a may be composed of vias of substrate 5g. Reflective plate 5b may be formed in substrate 5g. This also allows antenna apparatus 5 to radiate radio waves in the direction parallel to the surface of substrate 5g and in the direction normal to substrate 5g, thereby forming a wide-angle radiation pattern.

### Summary of Embodiment 2

As described above, reflective plate 5b and the portion of antenna element 5a extending from reflective plate 5b (first antenna-element portion) are formed inside substrate 5g, and the portion of antenna element 5a bent at a right angle and extending (second antenna-element portion) is formed on the surface of substrate 5g. This configuration also allows antenna apparatus 5 to form a wide-angle radiation pattern.

### Embodiment 3

In Embodiment 3, the portion of the antenna element parallel to the substrate surface (second antenna-element portion) is formed in the substrate (dielectric).

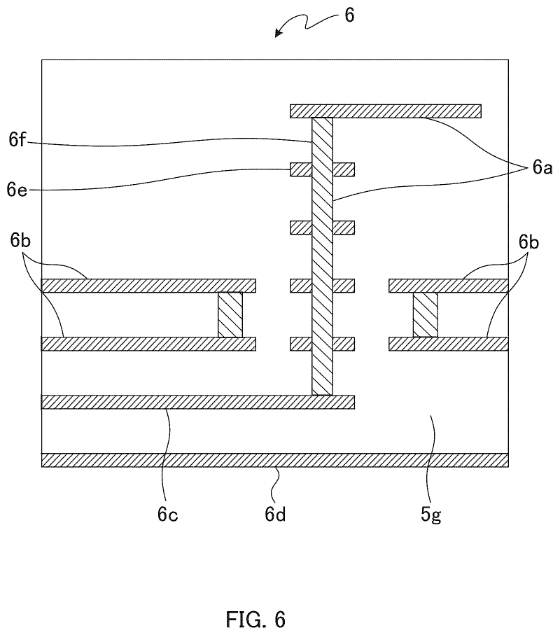

FIG. 6 is a side cross-sectional view of antenna apparatus 6 according to Embodiment 3. As illustrated in FIG. 6, antenna apparatus 6 includes antenna element 6a, reflective plate 6b, transmission line 6c, ground 6d, via lands 6e, vias 6f, and substrate 6g.

Substrate 6g is a dielectric substrate. In the example of FIG. 6, substrate 6g is an eight-layer laminated substrate. In the description of FIG. 6, the layers are referred to as the first layer, the second layer, . . . , and the eighth layer from the upper surface toward the bottom surface of substrate 6g. In substrate 6g, via lands 6e are formed in substrate 6g, and vias 6f are stacked on top of and below via lands 6e. Via lands 6e and vias of may be formed of copper.

Antenna element 6a has a shape bent in an L-shape. Antenna element 6a extends from the fifth layer to the second layer of substrate 6g, is bent by 90 degrees, and then is formed on the second layer of substrate 6g.

In L-shaped antenna element 6a, a portion extending from the fifth layer toward the second layer of substrate 6g (first antenna-element portion) is formed by vias 6f. The length of the first antenna-element portion is λg/4.

In L-shaped antenna element 6a, a portion formed on the second layer of substrate 6g (second antenna-element portion) has, for example, an elongated rectangular shape (see, e.g., hatched portion in FIG. 13). The second antenna-element portion is formed in substrate 6g. The length of the second antenna-element portion is equal to or longer than λg/4 and equal to or shorter than λg/2. The second antenna-element portion may be formed of copper foil.

Reflective plate 6b is formed in a solid pattern on the fifth and the sixth layers of substrate 6g. The two layers of reflective plate 6b are connected through vias 6f.

Reflective plate 6b is connected to a ground. Reflective plate 6b is formed on two layers in FIG. 6, but may be formed on one layer or may be formed on three or more layers. Reflective plate 6b may be formed of copper foil.

The second antenna-element portion is formed so as to overlap with reflective plate 6b (so as to be positioned above reflective plate 6b) when viewed from the side of the upper surface of substrate 6g. In other words, the second antenna-element portion is formed to be parallel to the surface of reflective plate 6b. The distance between reflective plate 6b and the second antenna-element portion is λg/4.

Transmission line 6c is formed on the seventh layer of substrate 6g. Transmission line 6c may be a strip line. One end of transmission line 6c is connected to the first antenna-element portion of antenna element 6a through via 6f, and the other end is connected to an RFIC (not shown), for example. Transmission line 6c supplies power from the RFIC to antenna elements 6a. Furthermore, transmission line 6c transmits power of the radio wave received by antenna element 6a to the RFIC. Transmission line 6c may be formed of copper foil.

Ground 6d is formed in a solid pattern on the eighth layer of substrate 6g. Ground 6d may be formed of copper foil.

As illustrated in FIG. 6, the second antenna-element portion of antenna element 6a may be formed in substrate 6g. This also allows antenna apparatus 6 to radiate radio waves in the direction parallel to the surface of substrate 6g and in the direction normal to substrate 6g, thereby forming a wide-angle radiation pattern.

### Summary of Embodiment 3

As described above, a portion of antenna element 6a bent at a right angle and extending (second antenna-element portion) is formed in substrate 6g. This configuration also allows antenna apparatus 6 to form a wide-angle radiation pattern.

### Embodiment 4

In Embodiment 4, an excitation source (feeding point) is placed at the bent portion of an L-shaped antenna element.

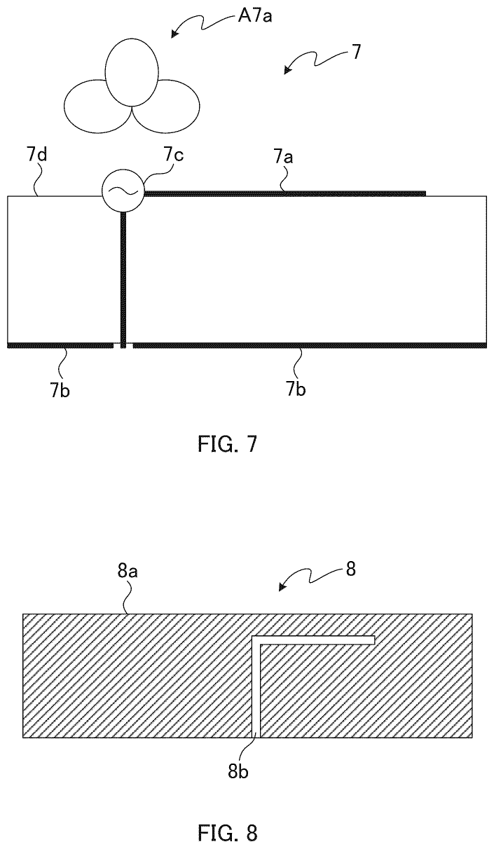

FIG. 7 is a side cross-sectional view of antenna apparatus 7 according to Embodiment 4. As illustrated in FIG. 7, antenna apparatus 7 includes antenna element 7a, reflective plate 7b, excitation source 7c, and substrate 7d. FIG. 7 also illustrates a radiation pattern of antenna apparatus 7 as indicated by arrow A7a.

Antenna element 7a has a shape bent in an L-shape. Antenna element 7a extends perpendicularly from the back surface toward the upper surface of substrate 7d, is bent by 90 degrees, and is formed on the upper surface of substrate 7d.

In L-shaped antenna element 7a, a portion extending from the back surface toward the upper surface of substrate 7d (first antenna-element portion) has a columnar shape, for example. The length of the first antenna-element portion is λg/4. The first antenna-element portion may be formed by a via, for example.

In L-shaped antenna element 7a, a portion formed on the upper surface of substrate 7d (second antenna-element portion) has, for example, an elongated rectangular shape (see, e.g., hatched portion in FIG. 13). The length of the second antenna-element portion is equal to or longer than λg/4 and equal to or shorter than λg/2. The second antenna-element portion may be formed of copper foil.

Reflective plate 7b is formed in a solid pattern on the back surface of substrate 7d. Reflective plate 7b is connected to a ground. Reflective plate 7b may be formed of copper foil.

The second antenna-element portion is formed so as to overlap with reflective plate 7b (so as to be positioned above reflective plate 7b) when viewed from the side of the upper surface of substrate 7d. In other words, the second antenna-element portion is formed to be parallel to the surface of reflective plate 7b. The distance between reflective plate 7b and the second antenna-element portion is λg/4.

Excitation source 7c is placed at the bent portion of antenna element 7a on the side of the upper surface of substrate 7d. Excitation source 7c supplies power to antenna element 7a.

Substrate 7d is a dielectric substrate. The thickness of substrate 7d is set so that the length of the first antenna-element portion of antenna element 7a is λg/4, for example. Note that, for a millimeter-wave band or a sub-terahertz-wave band, the thickness of substrate 7d is, for example, several hundred u to several mm, allowing the substrate to fit in a housing of a communication apparatus such as a smartphone or a tablet terminal.

As illustrated in FIG. 7, excitation source 7c may be placed at the bent portion of antenna element 7a. Antenna apparatus 7 can radiate radio waves in the direction parallel to the surface of substrate 4d and in the direction normal to substrate 4d as indicated by arrow A7a in FIG. 7, thereby forming a wide-angle radiation pattern.

### Summary of Embodiment 4

As described above, excitation source 7c is placed at a portion of antenna element 7a bent at a right angle. This configuration also allows antenna apparatus 6 to form a wide-angle radiation pattern.

### Embodiment 5

In Embodiment 5, an antenna element is formed by a slit.

FIG. 8 is a view of layer 8a in the laminated substrate of antenna apparatus 8 according to Embodiment 5 as viewed from the above. Antenna apparatus 8 includes layer 8a and antenna element 8b.

Layer 8a is a solid copper foil. Layer 8a is connected to a ground.

Antenna element 8b is configured by forming a slit (groove) in an L-shape in layer 8a. In other words, the portion of antenna element 8b has no copper foil in an L-shape. The slit may be referred to as a slot.

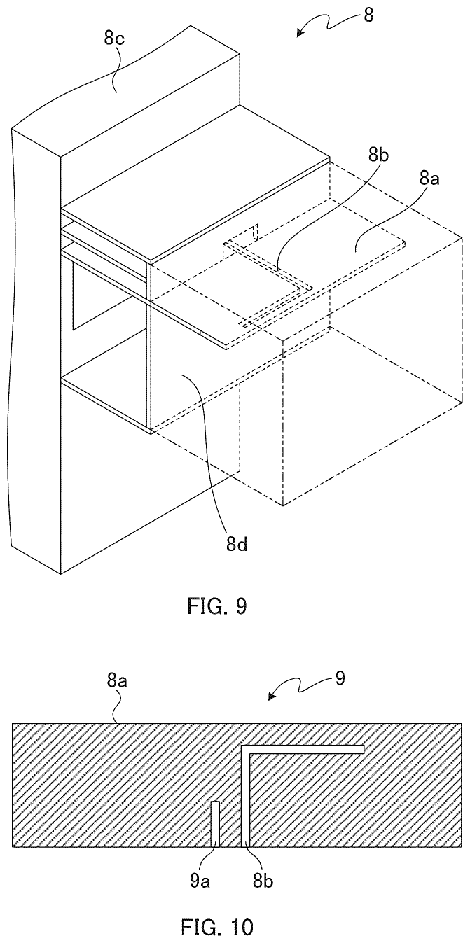

FIG. 9 is a perspective view of antenna apparatus 8 partially showing the interior of substrate 8c of antenna apparatus 8 according to Embodiment 5. In FIG. 9, the same components as those in FIG. 8 are denoted by the same reference numerals.

Layer 8a is formed to be parallel to the surface (upper surface) of substrate 8c. Reflective plate 8d is formed in a solid pattern and is formed so as to be perpendicular to the surface of layer 8a. For example, reflective plate 8d may be formed in a solid pattern by connecting a plurality of vias extending perpendicularly to the surface of layer 8a. Reflective plate 8d is connected to a ground.

Reflective plate 8d has an opening. Slit-like antenna element 8b formed in layer 8a passes through the opening formed in reflective plate 8d.

An excitation source (not shown) is placed on the opposite side from antenna element 8b across reflective plate 8d. The power (electric field) radiated from the excitation source propagates through slit-like antenna elements 8b. This causes radio waves to be radiated from antenna elements 8b.

In L-shaped antenna element 8b, the length of a portion extending perpendicularly from reflective plate 8d (first antenna-element portion) is λg/4. In L-shaped antenna element 8b, the length of a portion formed parallel to the surface of reflective plate 8d (second antenna-element portion) is equal to or longer than λg/4 and equal to or shorter than λg/2.

The second antenna-element portion is formed to be parallel to the surface of reflective plate 8d. The distance between reflective plate 8d and the second antenna-element portion is λg/4.

As illustrated in FIGS. 8 and 9, antenna element 8b may be formed by a slit. This also allows antenna apparatus 8 to radiate radio waves in the direction parallel to the surface of substrate 8c and in the direction normal to substrate 8c, thereby forming a wide-angle radiation pattern.

### Summary of Embodiment 5

As described above, antenna element 8b is formed by a slit, and reflective plate 8d is formed by connecting vias extending linearly. This configuration also allows antenna apparatus 8 to form a wide-angle radiation pattern.

### Embodiment 6

In Embodiment 6, a feeding line (transmission line) is formed by a slit.

FIG. 10 is a view of a layer in the laminated substrate of antenna apparatus 9 according to Embodiment 6 as viewed from the above. In FIG. 10, the same components as those in FIG. 8 are denoted by the same reference numerals. In the following, portions different from those in FIG. 8 will be described.

As illustrated in FIG. 10, feeding line 9a is formed to be parallel to the first antenna-element portion of antenna element 8b. The length of feeding line 9a may be shorter than that of the first antenna-element portion of antenna element 8b, and may be, for example, half the length of the first antenna-element portion.

Feeding line 9a is configured by linearly forming a slit (groove) in layer 8a. In other words, feeding line 9a has no copper foil in a straight line.

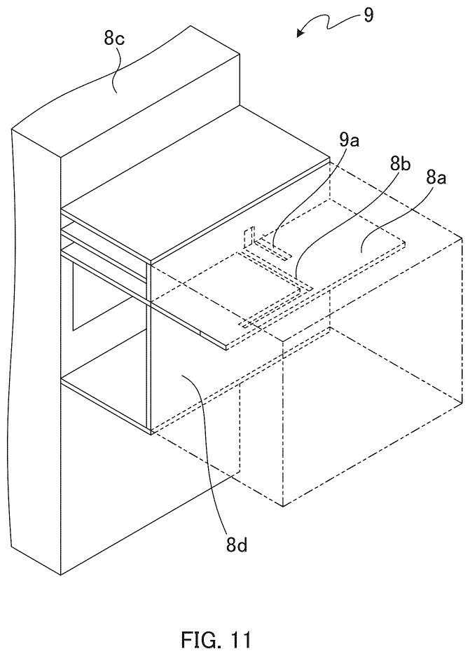

FIG. 11 is a perspective view of antenna apparatus 9 partially showing the interior of substrate 8c of antenna apparatus 9 according to Embodiment 6. In FIG. 11, the same components as those in FIG. 9 are denoted by the same reference numerals. In the following, portions different from those in FIG. 9 will be described.

Reflective plate 8d has an opening. The opening is formed between antenna 8b and feeding line 9a.

An excitation source (not shown) is placed on the opposite side from antenna element 8b across reflective plate 8d. The power (electric field) radiated from the excitation source propagates to antenna elements 8b through slit-like feeding line 9a. This causes radio waves to be radiated from antenna elements 8b.

### Summary of Embodiment 6

As described above, feeding line 9a is formed by a slit. This configuration also allows antenna apparatus 8 to form a wide-angle radiation pattern.

### Embodiment 7

In Embodiment 7, an array antenna apparatus including a plurality of antenna apparatuses will be described.

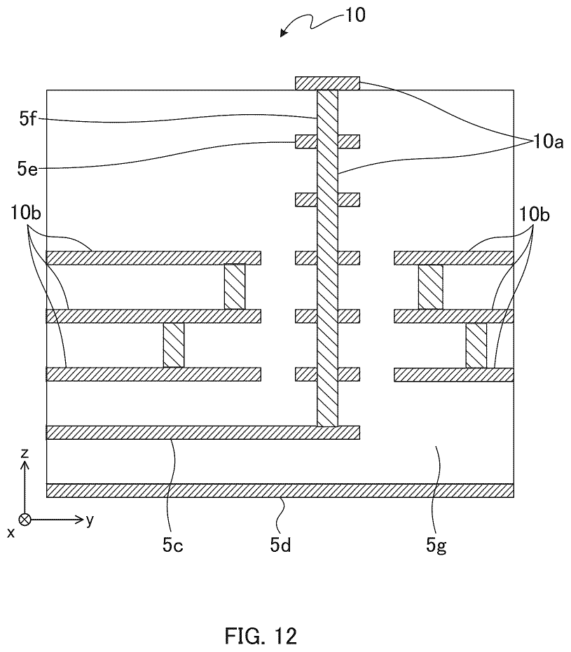

FIG. 12 is a side cross-sectional view of antenna apparatus 10 included in an array antenna apparatus according to Embodiment 7. In FIG. 12, the same components as those in FIG. 5 are denoted by the same reference numerals. In the following, portions different from those in FIG. 5 will be described. For antenna apparatus 10, x, y, and z axes illustrated in FIG. 12 are set.

Antenna apparatus 10 includes L-shaped antenna element 10a. The second antenna-element portion of antenna element 5a illustrated in FIG. 5 is formed on the first layer of substrate 5g so as to extend in the +y-axis direction from the portion bent in the L-shape, whereas the second antenna-element portion of antenna element 10a illustrated in FIG. 12 is formed on the first layer of substrate 5g so as to extend in the +x-axis direction from the portion bent in the L-shape.

Antenna apparatus 5 illustrated in FIG. 5 includes two-layer reflective plate 5b, but antenna apparatus 10 illustrated in FIG. 12 includes three-layer reflective plate 10b.

FIG. 13 is a top view of antenna apparatus 10 of FIG. 12. In FIG. 13, the same components as those in FIG. 12 are denoted by the same reference numerals. In FIG. 13, via 5f (first antenna-element portion) formed in substrate 5g and transmission line 5c are indicated by dotted lines. Dotted circle A13a illustrated in FIG. 13 indicates the border of the presence of reflective plate 10b. For example, the inside of circle A13a is a portion where reflective plate 10b is not formed, and the outside of circle A13a is a portion where reflective plate 10b is formed.

As also described in FIG. 12, the second antenna-element portion of antenna element 10a extends in the +x-axis direction from the portion bent in the L-shape. The second antenna-element portion of antenna element 10a is connected to transmission line 5c through via 5f constituting the first antenna-element portion.

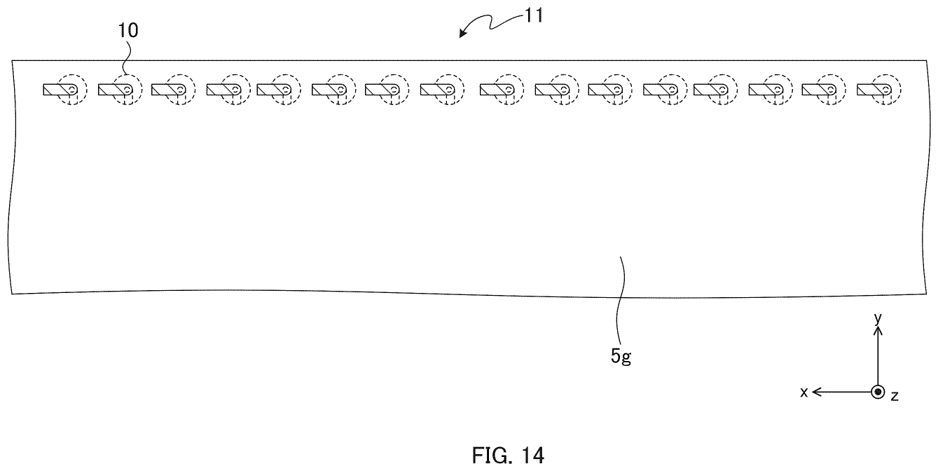

FIG. 14 is a top view of array antenna apparatus 11 according to Embodiment 7. In FIG. 14, the same components as those in FIG. 13 are denoted by the same reference numerals.

As illustrated in FIG. 14, array antenna apparatus 11 is an array antenna apparatus in which antenna apparatuses 10 are arrayed. In the example of FIG. 14, array antenna apparatus 11 includes 16 antenna apparatuses 10. The number of antenna apparatuses 10 is not limited to 16.

Antenna apparatus 10 is formed in the vicinity of the end of substrate 5g extending linearly. Antenna apparatus 10 is formed in a row along the end of substrate 5g extending linearly. The second antenna-element portion of antenna apparatus 10 is formed so as to be parallel to the straight end of substrate 5g. In other words, the second antenna-element portion of antenna apparatus 10 is formed so that the longitudinal direction thereof faces the x-axis direction. In other words, the second antenna-element portion of antenna apparatus 10 is formed so as to be parallel to the arrayed direction of antenna apparatus 10.

Array antenna apparatus 11 can control a beam direction by changing the amplitudes and phases of antenna apparatuses 10. Array antenna apparatus 11 can also form a wide-angle radiation pattern by changing the amplitudes and phases of antenna apparatuses 10.

### Summary of Embodiment 7

As described above, array antenna apparatus 11 includes a plurality of antenna apparatuses 10. Antenna apparatus 10 includes reflective plate 10b and antenna element 10a that extends perpendicularly from reflective plate 10b and is bent at a right angle. The length of the portion of antenna element 10a extending perpendicularly from reflective plate 10b (first antenna-element portion) is approximately ¼ of the guide wavelength to be radiated. The length of the portion of antenna element 10a bent at a right angle and extending (second antenna-element portion) is approximately ¼ or longer and approximately ½ or shorter of the guide wavelength. This allows antenna apparatus 4 to radiate radio waves in the direction parallel to the surface of substrate 5g and the direction normal to substrate 5g, thereby forming a wide-angle radiation pattern.

### <Simulation>

In the following, the simulation of the radiation pattern of array antenna apparatus 11 described in Embodiment 7 will be described.

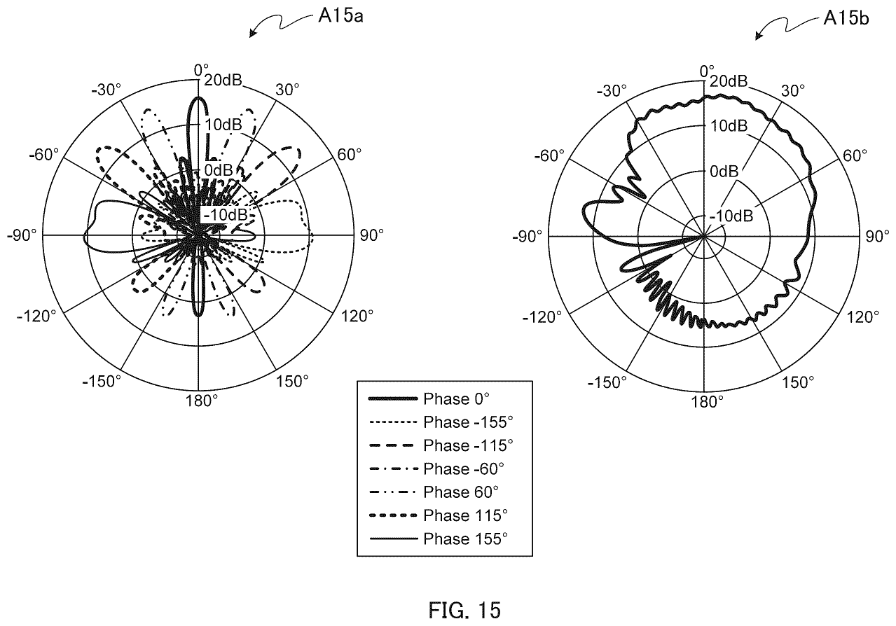

FIG. 15 is a diagram illustrating a simulation result of a radiation pattern of array antenna apparatus 11. FIG. 15 illustrates the simulation result of a radiation pattern for 150 GHz radio waves. The amplitude and phase of each antenna apparatus 10 of array antenna apparatus 11 was adjusted to simulate the radiation pattern.

Radiation pattern A15a on the left side of FIG. 15 illustrates a radiation pattern of array antenna apparatus 11 on the x-z plane. Zero degrees in radiation pattern A15a corresponds to the +z-axis direction of array antenna apparatus 11, and 90 degrees corresponds to the +x-axis direction.

Radiation pattern A15b on the right side of FIG. 15 illustrates a radiation pattern of array antenna apparatus 11 on the y-z plane. Zero degrees in radiation pattern A15a corresponds to the +z-axis direction of array antenna apparatus 11, and 90 degrees corresponds to the +y-axis direction.

As illustrated in radiation pattern A15b, array antenna apparatus 11 strongly radiates radio waves in the direction normal to the substrate (Zero-degree direction). Furthermore, array antenna apparatus 11 strongly radiates radio waves in the substrate horizontal direction. That is, array antenna apparatus 11 forms a wide-angle radiation pattern.

Arranging antenna apparatuses 10 as illustrated in FIG. 14 can obtain a preferable simulation result (wide-angle radiation pattern) as illustrated in FIG. 15. However, the arrangement of antenna apparatuses 10 of array antenna apparatus 11 is not limited to the example of FIG. 14. The directions of the second antenna-element portions of antenna apparatuses 10 may be appropriately changed according to the application of array antenna apparatus 11. For example, the second antenna-element portions of antenna apparatuses 10 illustrated in FIG. 14 may be formed parallel to the y-axis direction. For example, the directions of the second antenna-element portions of antenna apparatuses 10 illustrated in FIG. 14 may be different from each other.

Although the embodiments have been described above with reference to the drawings, the present disclosure is not limited to these examples. Obviously, a person skilled in the art would arrive at variations and modifications within a scope described in claims. It is understood that these variations and modifications are within the technical scope of the present disclosure. In addition, the components in the embodiments may be optionally combined without departure from the spirit of the present disclosure. Furthermore, the embodiments may be combined.

The numerical values such as the length and the angle described above may include approximations. For example, λg/4 may be read as λg/4 or approximately λg/4.

The components used in the description of the above embodiments may be partially or entirely implemented as an LSI that is an integrated circuit. The LSI may be individually formed as chips, or one chip may be formed so as to include a part or all of the components. The LSI may include a data input and output coupled thereto. The LSI herein may be referred to as an IC, a system LSI, a super LSI, or an ultra LSI depending on a difference in the degree of integration.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. Some non-limiting examples of such a communication apparatus include a phone (e.g., cellular (cell) phone, smartphone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus also may include an infrastructure facility, such as a base station, an access point, and any other apparatus, device or system that communicates with or controls apparatuses such as those in the above non-limiting examples.

The disclosure of U.S. Provisional Application No. 63/478,078, filed on Dec. 30, 2022, is incorporated herein by reference in its entirety.

### INDUSTRIAL APPLICABILITY

The present disclosure is useful for an antenna apparatus and an array antenna apparatus that each radiate radio waves in a wide-angle radiation pattern.

### REFERENCE SIGNS LIST

4 Antenna apparatus
4a Antenna element
4b Reflective plate
4c Excitation source
4d Substrate

1. An antenna apparatus, comprising:
a reflective plate; and
an antenna element that extends perpendicularly from the reflective plate and is bent at a right angle, wherein
a length of a portion of the antenna element extending perpendicularly from the reflective plate is approximately ¼ of a guide wavelength to be radiated, and
a length of a portion of the antenna element bent at a right angle and extending is approximately ¼ or longer and approximately ½ or shorter of the guide wavelength.

2. The antenna apparatus according to claim 1, wherein
an excitation source is placed at an end portion of the antenna element on a side of the reflective plate.

3. The antenna apparatus according to claim 1, wherein
an excitation source is placed at a portion of the antenna element bent at a right angle.

4. The antenna apparatus according to claim 1, wherein
the reflective plate and the portion of the antenna element extending perpendicularly from the reflective plate are formed inside a laminated substrate, and
the portion of the antenna element bent at a right angle and extending is formed on a surface of or inside the laminated substrate.

5. The antenna apparatus according to claim 4, wherein
the portion of the antenna element extending perpendicularly from the reflective plate is formed of a via, and
the reflective plate and the portion of the antenna element bent at a right angle and extending are formed of copper foil.

6. The antenna apparatus according to claim 1, wherein
the antenna element is formed by a slit.

7. The antenna apparatus according to claim 6, wherein
the reflective plate is formed by connecting vias extending linearly.

8. The antenna apparatus according to claim 1, wherein
the antenna element radiates a radio wave in a millimeter-wave band or a sub-terahertz-wave band.

9. An array antenna apparatus including a plurality of antenna apparatuses, wherein
each of the plurality of antenna apparatuses includes:
a reflective plate; and
an antenna element that extends perpendicularly from the reflective plate and is bent at a right angle,
a length of a portion of the antenna element extending perpendicularly from the reflective plate is approximately ¼ of a guide wavelength to be radiated, and
a length of a portion of the antenna element bent at a right angle and extending is approximately ¼ or longer and approximately ½ or shorter of the guide wavelength.

10. The array antenna apparatus according to claim 9, wherein
the plurality of antenna apparatuses is linearly arranged, and
a portion of each of the plurality of antenna apparatuses bent at a right angle and extending is formed to be parallel to a direction in which the plurality of antenna apparatuses is arranged.
